(19) United States
(12) Patent Application Publication
(10) Pub. No.: US 2025/0380043 A1
(43) Pub. Date: Dec. 11, 2025

(54) IMAGE ADJUSTMENT APPARATUS, IMAGE ADJUSTMENT METHOD, AND COMPUTER READABLE MEDIUM

(71) Applicant: JVCKENWOOD Corporation, Yokohama-shi (JP)

(72) Inventors: Tadashi ISHIWATA, Yokohama-shi (JP); Keita Hayashi, Yokohama-shi (JP); Hirofumi Yamamoto, Yokohama-shi (JP); Keiji Tsuchiya, Yokohama-shi (JP); Yasufumi Nakaaki, Yokohama-shi (JP)

(21) Appl. No.: 19/301,314

(22) Filed: Aug. 15, 2025

Related U.S. Application Data
(63) Continuation of application No. PCT/JP2024/003061, filed on Jan. 31, 2024.

(30) Foreign Application Priority Data
Feb. 21, 2023 (JP) 2023-024839

(51) Int. Cl. H04N 23/61; G06V 20/10; G06V 20/58; H04N 23/11; H04N 23/13

(52) U.S. Cl. CPC H04N 23/61; G06V 20/194; G06V 20/58; H04N 23/11; H04N 23/13

(57) ABSTRACT

An imaging system includes: an object detection unit configured to detect objects included in a first image; a selection unit configured to select a target object from among the objects included in the first image by referring to priority information given according to a temperature of each object; an area specifying unit configured to specify a determination area including a target object in a second image; a counting unit configured to count the number of saturated pixels that are saturated in the determination area; a determination unit configured to determine whether or not a rate of the saturated pixels in the determination area is equal to or greater than a threshold; and a change unit configured to change, when the rate is equal to or greater than the threshold, a value of a gain or an offset in a second image-capturing element.

### CROSS REFERENCE TO RELATED APPLICATION

This application is a bypass continuation application of PCT/JP2024/003061 filed on Jan. 31, 2024, which is based upon and claims the benefit of priority from Japanese patent application No. 2023-024839, filed on Feb. 21, 2023, the disclosure of which is incorporated herein in its entirety by reference.

The present disclosure relates to an image adjustment apparatus, an image adjustment method, and a computer readable medium.

### BACKGROUND

Japanese Unexamined Patent Application Publication No. 2014-191668 discloses a vehicle display control apparatus mounted on a vehicle. This vehicle display control apparatus acquires a visible light image and an infrared image. The vehicle display control apparatus detects a target object outside the vehicle based on the infrared image. The control apparatus detects an overlapping area from the infrared image based on an area of a visible light image outside the vehicle. When a target object is present within the overlapping area, the control apparatus superimposes information on the target object on the visible light image and transmits this image as a display image.

### SUMMARY

Some image sensors of a far-infrared camera use bolometers that receive far-infrared rays and generate heat. In a far-infrared camera that uses a bolometer or the like, even when a uniform temperature surface such as a blackbody furnace is imaged, output values of respective pixels are not uniform and vary for each pixel. Further, when the environment temperature increases, the variation of the output value for each pixel tends to increase.

In a far-infrared camera, the temperature resolution is determined by a gain being set. However, if the temperature resolution is set high (i.e., if designed in such a way that a small temperature difference can be captured), the effect of the variation of an output value for each pixel increases. In this case, if the temperature of an imaging environment is high or a high-temperature object is imaged, for example, it is possible that the output value of the pixel may exceed a signal processing range of the far-infrared camera and may be saturated. On the other hand, if the temperature resolution is reduced in order to prevent saturation, it is possible that two objects with different temperatures may appear as if they are the same object. On the other hand, the temperature measurement range can be adjusted by offset. When the output value of the pixel is saturated, it can be adjusted to an output value that is not saturated by performing offset.

The present disclosure has been made in view of the aforementioned circumstances, and an object of the present disclosure is to provide an image adjustment apparatus and an image adjustment method capable of acquiring, for a target object whose images are to be captured by a far-infrared camera, a far-infrared image whose temperature resolution is high and where there is no saturation.

An image adjustment apparatus according to one aspect of this embodiment includes: a first image acquisition unit configured to acquire a first image captured by a first image-capturing element; a second image acquisition unit configured to acquire a second image captured by a second image-capturing element that detects far-infrared light; an object detection unit configured to detect objects included in the first image; a selection unit configured to select a target object from among the objects included in the first image by referring to priority information given to objects; an area specifying unit configured to specify a determination area including the target object in the second image; a counting unit configured to count the number of saturated pixels that are saturated in the determination area; a determination unit configured to determine whether or not a rate of the saturated pixels in the determination area is equal to or greater than a threshold; and a change unit configured to change, when the rate is equal to or greater than the threshold, a value of a gain or an offset in the second image-capturing element.

An image adjustment method according to one aspect of this embodiment includes: a step of acquiring a first image captured by a first image-capturing element; a step of acquiring a second image captured by a second image-capturing element that detects far-infrared light; a step of detecting objects included in the first image; a step of selecting a target object from among the objects included in the first image by referring to priority information given to objects; a step of specifying a determination area including the target object in the second image; a step of counting the number of saturated pixels that are saturated in the determination area; a step of determining whether or not a rate of the saturated pixels in the determination area is equal to or greater than a threshold; and a step of changing, when the rate is equal to greater than the threshold, a value of a gain or an offset in the second image-capturing element.

A program according to one aspect of this embodiment is a program for causing a processor that controls an image adjustment apparatus to perform: a step of acquiring a first image captured by a first image-capturing element; a step of acquiring a second image captured by a second image-capturing element that detects far-infrared light; a step of detecting objects included in the first image; a step of selecting a target object from among the objects included in the first image by referring to priority information given to objects; a step of specifying a determination area including the target object in the second image; a step of counting the number of saturated pixels that are saturated in the determination area; a step of determining whether or not a rate of the saturated pixels in the determination area is equal to or greater than a threshold; and a step of changing, when the rate is equal to greater than the threshold, a value of a gain or an offset in the second image-capturing element.

According to this embodiment, it is possible to provide an image adjustment apparatus, an image adjustment method, and a program capable of acquiring, for a target object, which is a target to be imaged, a far-infrared image whose temperature resolution is high and where there is no saturation.

### BRIEF DESCRIPTION OF THE DRAWINGS

FIG. 1 is a diagram schematically showing a configuration of an imaging system;

FIG. 2 is a diagram showing far-infrared images before and after correction;

FIG. 3 is a diagram for describing pixel data when variation of output characteristics is small;

FIG. 4 is a diagram for describing pixel data when variation of output characteristics is large;

FIG. 5 is a block diagram showing a configuration of a far-infrared camera of an imaging system;

FIG. 6 is a block diagram showing a configuration of a control apparatus of the imaging system;

FIG. 7 is a diagram showing an example of an object detected by an object detection unit;

FIG. 8 is a diagram showing an example of a target object selected by a selection unit;

FIG. 9 is a diagram showing an example of a determination area specified by an area specifying unit;

FIG. 10 is a diagram showing an example of a determination area specified by the area specifying unit based on environment information;

FIG. 11 is a diagram showing an example of a target object selected by a selection unit based on the environment information; and

FIG. 12 is a flowchart showing an image adjustment method.

### DETAILED DESCRIPTION

Hereinafter, with reference to the drawings, specific embodiments to which the present disclosure is applied will be described in detail. However, the present disclosure is not limited to the following embodiments. Further, for the sake of clarification of the description, the following descriptions and drawings are simplified as appropriate.

An imaging system according to this embodiment can be mounted on a mobile body such as a vehicle. For example, the imaging system is used as in-vehicle equipment as a dashboard camera. The imaging system may also be used as a surveillance camera or a security camera.

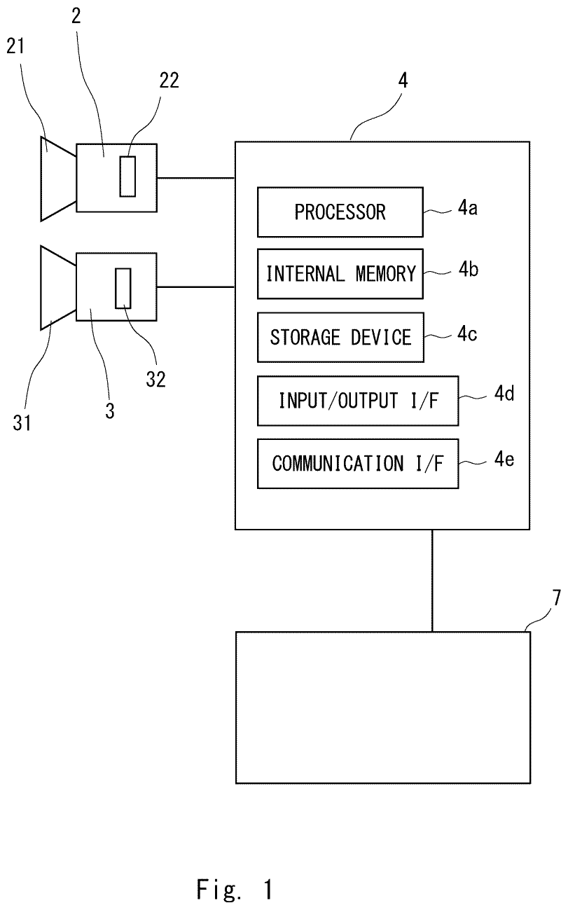

FIG. 1 is a block diagram showing a schematic system configuration of an imaging system according to this embodiment. An imaging system 1 according to this embodiment includes a visible light camera 2, a far-infrared camera 3, and a control apparatus 4. While one example of the imaging system 1 shown in FIG. 1 further includes a display 7, the imaging system 1 may not include the display 7.

The visible light camera 2 detects visible light and images a subject. The visible light camera 2 may capture a moving image or sequential still images. It is assumed that the image captured by the visible light camera 2 is a visible light image or a first image. The visible light camera 2 is communicatively connected to the control apparatus 4 wirelessly or by a wire. The visible light camera 2 images the subject at a predetermined angle of view.

Specifically, the visible light camera 2 includes a lens unit 21 and an image-capturing element 22. The image-capturing element 22 is a photodetector such as a Charge Coupled Device (CCD) sensor or a Complementary Metal-Oxide-Semiconductor (CMOS) sensor. The image-capturing element 22 includes a plurality of pixels (light receiving elements) aligned in a horizontal direction and a vertical direction. The lens unit 21 is arranged on an incident side of the image-capturing element 22. The lens unit 21 forms an image of the subject on the image-capturing element 22. The image-capturing element 22 detects visible light refracted by the lens unit 21. The lens unit 21 includes at least one lens. For example, the lens unit 21 may include a plurality of lenses such as a zoom lens and a focusing lens. Note that the image-capturing element 22 is also referred to as a first image-capturing element.

The far-infrared camera 3 detects far-infrared light (also referred to as far-infrared rays) and images the subject. The far-infrared camera 3 captures a moving image. Alternatively, the far-infrared camera 3 captures sequential still images. The image captured by the far-infrared camera 3 is referred to as a far-infrared image, a thermal image, or a second image. The far-infrared camera 3 is communicatively connected to the control apparatus 4 by a wire or wirelessly. The far-infrared camera 3 images the subject at a predetermined angle of view.

The far-infrared camera 3 includes a lens unit 31 and an image-capturing element 32. The image-capturing element 32 is a photodetector such as a microbolometer. The image-capturing element 32 may either be a thermal type (uncooled type) element or a quantum type (cooled type) element. The image-capturing element 32 includes a plurality of pixels aligned in a horizontal direction and a vertical direction. The lens unit 31 is arranged on an incident side of the image-capturing element 32. The lens unit 31 forms an image of the subject on the image-capturing element 32. The image-capturing element 32 detects far-infrared light refracted by the lens unit 31. The lens unit 31 may include a plurality of lenses such as a zoom lens and a focusing lens. The image-capturing element 32 is also referred to as a second image-capturing element. An output bit width of the far-infrared camera 3 is, for example, 10 to 14 bits.

The far-infrared camera 3 and the visible light camera 2 may be provided separately from each other as long as they can capture images in the same direction. The imaging area of the far-infrared camera 3 and that of the visible light camera 2 may be the same or the imaging area of one of the far-infrared camera 3 and the visible light camera 2 may be included in the imaging area of the other one of the far-infrared camera 3 and the visible light camera 2. The relative position and the direction in which the visible light camera 2 is attached relative to the far-infrared camera 3 are already known.

The far-infrared camera 3 and the visible light camera 2 may be arranged coaxially. In this case, a beam splitter or the like that divides the far-infrared light and the visible light may be provided in front of the far-infrared camera 3 and the visible light camera 2.

The control apparatus 4 has a hardware configuration of a normal computer including, for example, a processor 4a such as a Central Processing Unit (CPU) or a Graphics Processing Unit (GPU), an internal memory 4b such as a Random Access Memory (RAM) or a Read Only Memory (ROM), a storage device 4c such as a Hard Disk Drive (HDD) or a Solid State Drive (SSD), an input/output I/F 4d for connecting peripheral devices such as the display 7, and a communication I/F 4e that performs communication with equipment outside the apparatus. The control apparatus 4 can perform image processing and control that will be described later by performing a computer program stored in the storage device 4c.

The control apparatus 4 is communicatively connected to the display 7. The control apparatus 4 can be connected to the display 7 by a wire or wirelessly. The control apparatus 4 performs image processing on far-infrared image data. The control apparatus 4 may then cause the display 7 to display the far-infrared image. The control apparatus 4 may further cause the display 7 to display a visible light image.

The display 7, which is, for example, a display apparatus including a liquid crystal panel or an organic electroluminescent panel, is provided at a location where it can be visually recognized by a user. The display 7 displays an image captured by the far-infrared camera 3 via the control apparatus 4.

With the above-described configuration, the control apparatus 4 causes the display 7 to display the far-infrared image captured by the far-infrared camera 3 in an aspect in which the far-infrared image can be visually recognized by the user. Accordingly, the control apparatus 4 can cause the user to recognize surrounding objects. When the imaging system 1 does not include the display 7, the control apparatus 4 may store the far-infrared image captured by the far-infrared camera 3 in an external storage device or the like that is not shown in the drawing. Further, the control apparatus 4, the far-infrared camera 3, and the display 7 may be configured as an integrated imaging apparatus.

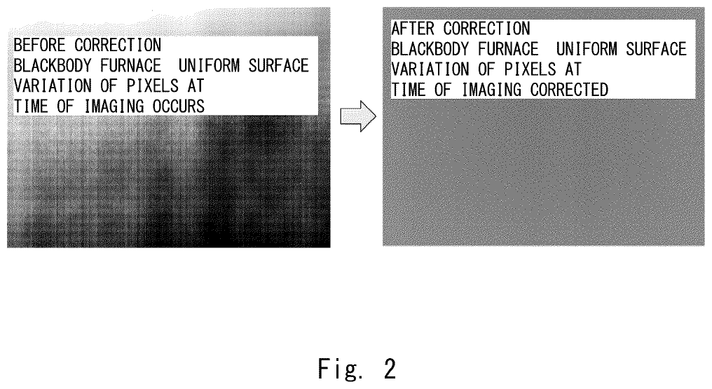

Hereinafter, a problem in a case where the far-infrared camera 3 that captures far-infrared images is used will be described. The control apparatus 4 performs Non-Uniformity Correction (NUC) on far-infrared image data. The NUC corrects variation of a pixel output. FIG. 2 is a diagram showing an image before correction (before NUC) and an image after correction (after NUC). FIG. 2 shows far-infrared images obtained by capturing a uniform surface (blackbody furnace) whose temperature is uniform.

Since unevenness occurs in the image before correction, it can be found that there is variation of the pixel output. That is, even in a case where a subject whose temperature is uniform is imaged, variation occurs in output characteristics of the bolometer of each pixel.

The variation of the output tends to be large as the environment temperature of the image-capturing element 32 increases even after the correction is performed. Further, the output of the bolometer is an AD-converted digital signal, and there is a limitation in the bit width of the output range. For example, the output bit width of the bolometer is often 10-14 bits. Therefore, when the output value of a pixel exceeds this range, saturation occurs and an abnormal image is output since normal signal processing cannot be performed.

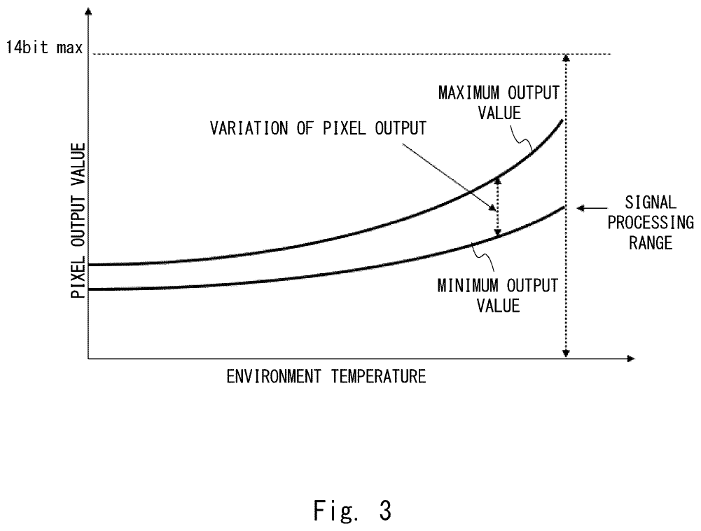

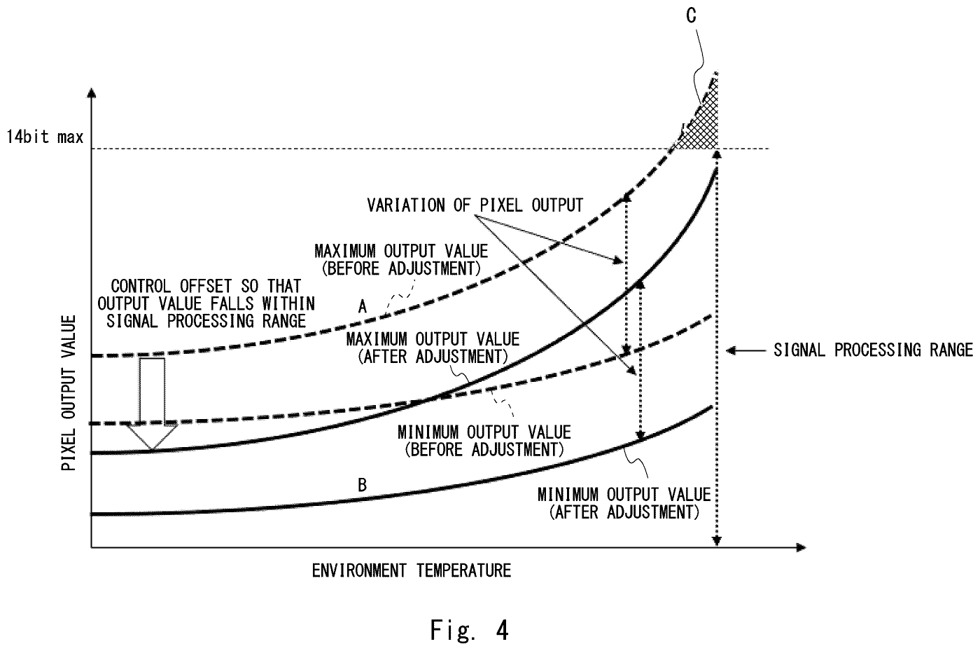

With reference to FIGS. 3 and 4, output characteristics in a case where the gain of the image-capturing element 32 is low and output characteristics in a case where the gain of the image-capturing element 32 is high will be described. FIGS. 3 and 4 show data of a pixel output value of the image-capturing element 32 in a far-infrared image obtained by imaging a subject having a uniform temperature. The horizontal axis indicates the environment temperature and the vertical axis indicates the pixel output value of the image-capturing element 32. In this example, the signal processing range of the pixel output value is a 14-bit width. Further, the two lines in each of FIGS. 3 and 4 show a maximum output value and a minimum output value that occur due to the variation of the pixel output value. FIG. 3 shows the output characteristics when the gain is low, and FIG. 4 shows the output characteristics when the gain is high.

As the environment temperature increases, the output value increases as well. Furthermore, as the environment temperature increases, the variation between two pixels increases as well. Since the gain is low in FIG. 3, the change is not very large. There is no problem since the output values are within the signal processing range.

In FIG. 4, the gain is set higher than that in FIG. 3. Therefore, the variation of the output value in FIG. 4 becomes greater than the variation of the output values in FIG. 3 in accordance with the increase in the environment temperature.

The graph A shown by the dotted line in FIG. 4 is one example of characteristics in the case where the gain is high. As the environment temperature increases, the output value increases sharply. Accordingly, when the environment temperature becomes high, the output value exceeds the signal processing range of 14 bits and saturation occurs (area C). When this phenomenon occurs, signal processing is out of control and a normal image cannot be output. In order to avoid this situation, it is required to decrease the offset of the sensor output to control the output value as shown in the graph B shown by the solid line in FIG. 4. In the graph B shown by the solid line in FIG. 4, the output value falls within the range of signal processing. That is, even under a high environment temperature, the far-infrared camera 3 can output a normal image.

In this embodiment, the control apparatus 4 detects an object and sets the gain and the offset of the image-capturing element 32. The aforementioned configuration prevents objects in the image from appearing abnormal due to saturation. The control apparatus 4 can constantly output normal images.

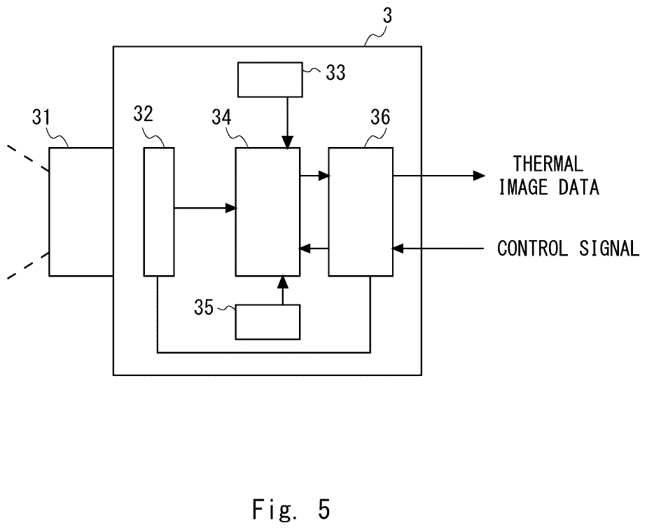

Next, a configuration of the far-infrared camera 3 will be described. FIG. 5 is a block diagram schematically showing a detailed configuration of the far-infrared camera 3. The far-infrared camera 3 includes the lens unit 31, the image-capturing element 32, a data storage unit 33, an adjustment unit 34, a temperature sensor 35, and a transmission device 36. The data storage unit 33, the adjustment unit 34, and the like may be mounted on a control circuit including a Micro Controller Unit (MCU), or may be mounted on the control apparatus 4. Further, the far-infrared camera 3 may include a shutter (not shown), and so on.

The lens unit 31 forms the far-infrared light from the subject on a light receiving surface of the image-capturing element 32. The lens unit 31 includes at least one lens. The lens unit 31 may include, for example, a plurality of lenses such as a zoom lens and a focusing lens.

The image-capturing element 32 includes a plurality of pixels. Each of these pixels of the image-capturing element 32 receives an infrared light from the subject. It is therefore possible to capture a far-infrared image of the subject. For example, the image-capturing element 32 has a microbolometer for detecting far-infrared rays. The image-capturing element 32 includes a plurality of pixels aligned in a two-dimensional array. The detection value (detection signal) of each pixel forms a far-infrared image of the subject.

The transmission device 36 serves as an interface for transmitting various kinds of signals and data to the control apparatus 4. The transmission device 36 transmits far-infrared image data to the control apparatus 4. Further, the transmission device 36 receives a control signal from the control apparatus 4. For example, the transmission device 36 receives a control signal for correcting the offset or the gain that will be described later. Further, the transmission device 36 may transmit lens information regarding the zoom and the focus of the lens unit 31. The transmission device 36 or the adjustment unit 34 may include an A/D converter that converts an analog signal into a digital signal.

The temperature sensor 35 measures the temperature in the environment in which the far-infrared camera 3 is used. Since the temperature sensor 35 is mounted inside the far-infrared camera 3, the temperature measured in the temperature sensor 35 is set as an internal temperature (or an environment temperature). The internal temperature is used for adjustment in the adjustment unit 34. Specifically, the adjustment unit 34 uses different tables according to the internal temperature.

The data storage unit 33 stores adjustment data for adjusting a detection value of each pixel of the image-capturing element 32. The adjustment data, which includes values of the gain and the offset, has, for example, a form of a table. The gain table is a table showing the value of the gain set for each pixel. The offset table is a table showing the value of the offset set for each pixel.

The adjustment unit 34 adjusts the output value of the image-capturing element 32. Specifically, the adjustment unit 34 reads the offset and the gain for adjustment stored in the data storage unit 33, and adjusts the output value of the image-capturing element 32. Then the adjustment unit 34 outputs the adjusted output value to the transmission device 36. That is, a set of the output values adjusted by the adjustment unit 34 forms far-infrared image data.

Here, the gain is a value for adjusting the temperature resolution with which images can be captured, and the offset is a value for adjusting the measurement range of the temperature. If the adjusted output value is above the signal processing range, saturation occurs. If there is a large number of saturated pixels in the far-infrared image data, the obtained image becomes an abnormal image, and it becomes difficult to recognize an object. In order to avoid this situation, in the far-infrared camera, a table of the values of the gain and the offset according to the environment temperature is normally set.

The data storage unit 33 stores, for example, a table for low temperature, a table for ambient temperature, and a table for high temperature. When the internal temperature is lower than a first threshold temperature, the table for low temperature is used. When the internal temperature is equal to or higher than a second threshold temperature, the table for high temperature is used. The first threshold temperature is lower than the second threshold temperature. The table for ambient temperature is used in a range equal to or greater than the first threshold temperature but is lower than the second threshold temperature. A gain table and an offset table are set for each of the temperature ranges. As a matter of course, the setting range of the temperature for switching the tables is not limited to three stages. The tables can be switched in the setting range of two stages. The adjustment unit 34 uses the tables by switching them according to the internal temperature. That is, the adjustment unit 34 reads a table according to the internal temperature.

As described above, the gain and the offset are changed according to the internal temperature. However, when a high-temperature object is shown in a far-infrared image, saturation may occur even after the gain and the offset are adjusted according to the internal temperature. The control apparatus 4 changes the setting of at least one of the gain or the offset based on a result of image processing that will be described later. This prevents the far-infrared image from being the abnormal image as described above.

The occurrence of the abnormal image can be avoided by changing the setting of the gain and the offset. Therefore, it is determined whether the control apparatus 4 should change the setting of the gain and the offset. Then the control apparatus 4 changes the values of the gain and the offset based on the result of the determination. It is therefore possible to prevent an abnormal image from being generated. The control apparatus 4 determines whether or not saturation of the pixel output value occurs by making a determination in a range of one object.

The imaging system 1 is used as, for example, in-vehicle equipment. There is a situation where, in midsummer, the road surface is heated by sunlight during the day and the temperature does not fall even at night. There is another situation where, at night, pedestrians and the like cannot be seen with naked eyes or the visible light camera 2 due to backlighting from lights of other vehicles, but the pedestrians and the like can be imaged by using the far-infrared camera 3. Under these circumstances, the far-infrared camera 3 needs to have appropriate temperature resolution. That is, if output values of the far-infrared camera 3 are set to include high-temperature objects as well, it is possible that output values of pixels between objects may be close to each other, and the color of one object may become the same as the color of another object whose temperature is close to the one object, making it impossible to recognize these objects as separate objects. That is, it is possible that the temperature of the road surface and that of a pedestrian may be close to each other, and the road surface and the pedestrian may be indistinguishable from each other in the image. Therefore, the control apparatus 4 allows saturation of output values for objects whose temperatures are high and do not affect traveling. On the other hand, the control apparatus 4 can adjust an image in such a way that objects that affect traveling can be distinguished by increasing the temperature resolution of the far-infrared camera.

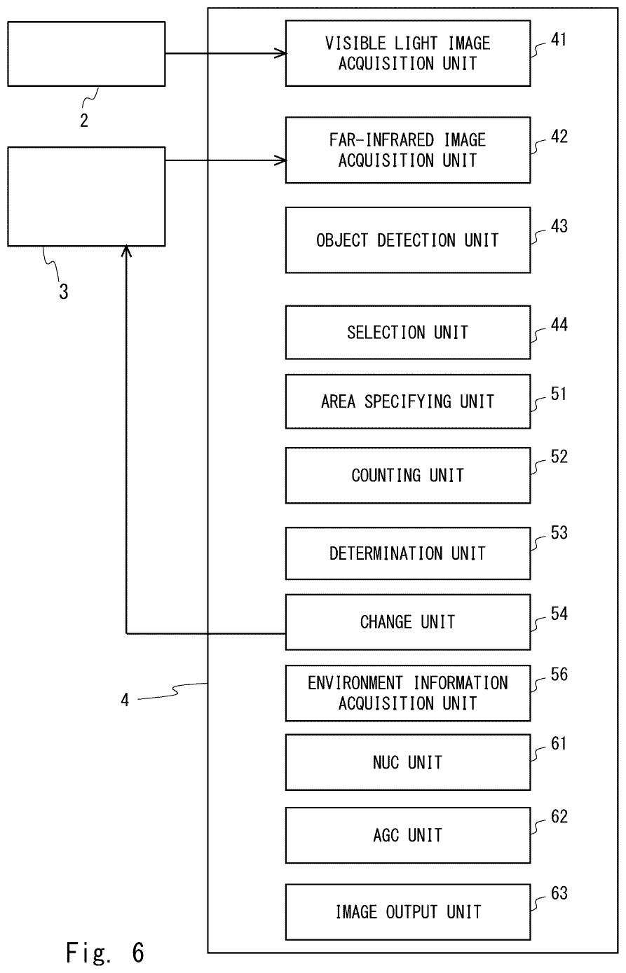

FIG. 6 is a control block diagram showing a configuration of the control apparatus 4. The control apparatus 4 includes a visible light image acquisition unit 41, a far-infrared image acquisition unit 42, an object detection unit 43, a selection unit 44, an area specifying unit 51, a counting unit 52, a determination unit 53, and a change unit 54. The control apparatus 4 may further include an environment information acquisition unit 56, an NUC unit 61, an Auto Gain Control (AGC) unit 62, and an image output unit 63.

The visible light camera 2 is connected to the visible light image acquisition unit 41. The visible light image acquisition unit 41 acquires a visible light image captured by the visible light camera 2. The visible light image acquisition unit 41 is also referred to as a first image acquisition unit. The visible light image acquired by the visible light image acquisition unit 41 is also referred to as a first image.

The far-infrared camera 3 is connected to the far-infrared image acquisition unit 42. The far-infrared image acquisition unit 42 acquires a far-infrared image captured by the far-infrared camera 3. The far-infrared image acquisition unit 42 is also referred to as a second image acquisition unit. The far-infrared image acquired by the far-infrared image acquisition unit 42 is also referred to as a second image.

The object detection unit 43 detects objects included in the visible light image. For example, the object detection unit 43 detects objects in the visible light image by performing image processing on the visible light image. For example, the object detection unit 43 detects a human (pedestrian), a bicycle, a motorbike, an automobile, an animal such as a dog, a building, a street lamp, the sun, a road, or the like. The object here includes a human, an animal, or the like. The object detection unit 43 can specify the objects by image processing such as edge detection or pattern matching. The object detection unit 43 can also detect the objects using a machine learning model such as a Convolutional Neural Network (CNN).

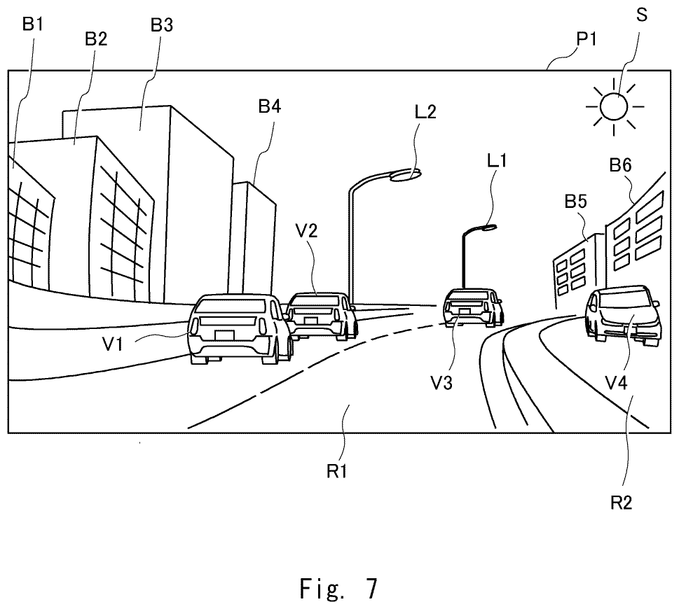

FIG. 7 is a diagram showing one example of the objects detected by the object detection unit 43. A visible light image P1 includes vehicles V1-V4, street lamps L1 and L2, sun S, buildings B1-B6, and roads R1-R2. The object detection unit 43 detects each of these objects by image processing. The object detection unit 43 detects a pixel address in accordance with the position and the size of each object. Accordingly, the area of each object in the visible light image is specified. Then attribute information indicating the type or the name is attached to each object. The object detection unit 43 stores data indicating the result of the detection in a memory or the like.

The selection unit 44 selects a target object, which is an object that affects traveling, from among the objects included in the visible light image. For example, the selection unit 44 stores priority information indicating the priority for each object for selecting the target object. The priority information is given in accordance with the type of the object. Here, the selection unit 44 does not select an object that has an extremely high temperature as the target object.

The targets that affect traveling are, for example, objects that need to be checked for safe traveling. Specifically, the targets that affect traveling are vehicles, motorbikes, pedestrians, or bicycles, and the priority is set in an order of vehicles, motorbikes, pedestrians, and bicycles. On the other hand, high-temperature objects whose temperatures are equal to or higher than a predetermined temperature are not selected as the target object. The high-temperature objects whose temperatures are equal to or higher than the predetermined temperature may include, for example, the sun, street lamps, lava, or high-temperature hot springs that people cannot enter. In midsummer, for example, a road formed of asphalt or a black building may be set as high-temperature objects. Further, when a vehicle is in a visible light image, parts of the vehicle may be specified and each part may be specified as an object. For example, high-temperature parts such as the muffler and the hood can be specified in an image of a vehicle. If the gain and the offset set in accordance with an object that has an extremely high temperature are used, it is possible that objects having normal temperatures may not be appropriately imaged. That is, other vehicles, pedestrians and the like cannot be imaged at appropriate temperature resolution. Accordingly, the aforementioned high-temperature objects are excluded from the candidates for the target object so that they are not selected as the target object. However, even high-temperature objects may be given priority if necessary.

The priority of the objects may be set in an order in which they are assumed to have the highest temperature excluding objects with extremely high temperatures. It is assumed, for example, that vehicles have temperatures higher than those of motorbikes, humans, bicycles, and the like. Therefore, higher priority is given to the vehicles compared to motorbikes, humans, and bicycles. For example, a memory or the like stores priority information indicating the priority in accordance with the temperature of the object. Then the selection unit 44 selects the target object by referring to the data of the priority information. That is, the selection unit 44 selects the object with the highest priority among the objects detected from the visible light image as the target object. As a matter of course, the number of target objects is not limited to one and two or more target objects may be selected. When two or more target objects are selected, the selection unit 44 sets objects of up to which priority order should be considered as the target objects.

Higher priority may be given to objects that need to be appropriately imaged without saturation in a far-infrared image. For example, when the imaging system 1 is a security system, it is required to appropriately capture images of a human in the camera, a robot in a building, an apparatus installed in the building, and so on. Accordingly, higher priority may be given to objects that need attention in order to prevent saturation of pixels. It is therefore possible to appropriately capture images by setting the gain and the offset for objects having higher priority.

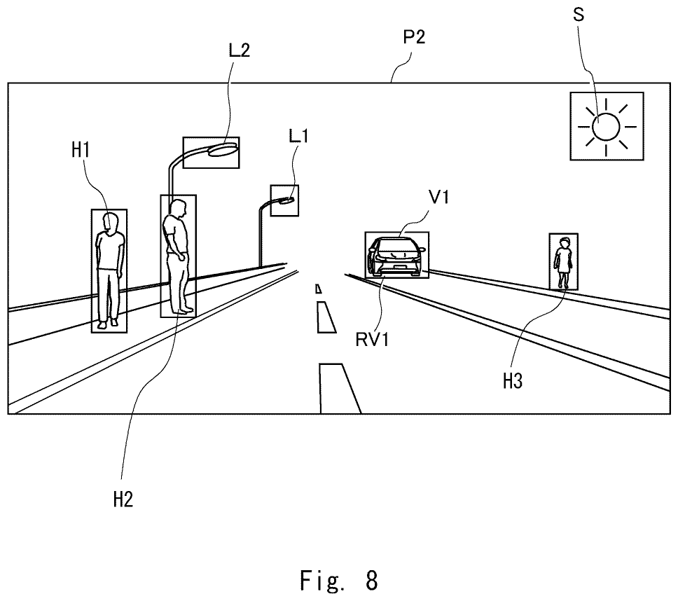

FIG. 8 is a diagram for describing one example for selecting a target object by referring to the priority. A visible light image P2 shown in FIG. 8 includes a vehicle V1, humans H1-H3, the sun S, and street lamps L1 and L2. That is, the object detection unit 43 detects each of the vehicle V1, the humans H1-H3, the sun S, and the street lamps L1 and L2. Since the sun S and the street lamps L1 and L2 are high-temperature objects, they are not the target object (priority is not given). Further, the priority of vehicles is higher than that of humans. Accordingly, the selection unit 44 selects the vehicle V1 as the target object.

The area specifying unit 51 specifies a determination area including a target object in a far-infrared image. The area specifying unit 51 converts a pixel address in a visible light image into a pixel address in a far-infrared image based on the relative position and direction of the far-infrared camera 3 relative to the visible light camera 2. With this configuration, the area specifying unit 51 can specify the determination area corresponding to the target object. As shown in FIG. 8, the area specifying unit 51 sets a rectangular area including the vehicle V1 as a determination area RV1. As a matter of course, the shape of the determination area specified by the area specifying unit 51 is not limited to a rectangular frame. For example, the determination area may have a shape according to the external shape of the object. Further, the determination area may not include the whole target object. That is, it is sufficient that the determination area include at least a part of the target object.

The relative position and the direction in which the visible light camera 2 is mounted relative to the far-infrared camera 3 are already known. The area specifying unit 51 stores data regarding the relative mounting position and the mounting direction. The area specifying unit 51 includes a conversion expression and a conversion table for converting a pixel address of the visible light image into a pixel address of the image-capturing element 32. The conversion expression and the conversion table can be created based on design data of the mounting position and the mounting direction.

Further, when the target object includes a high-temperature part whose temperature is equal to or higher than a predetermined temperature, this high-temperature part may be excluded from the determination area. For example, the temperatures of the hood, the muffler, and the like of the vehicle V1 can become extremely high. The high-temperature parts such as the hood and the muffler may be excluded from the determination area RV1. That is, the area specifying unit 51 may specify, as a determination area, the part excluding the high-temperature object from the area of the target object.

The counting unit 52 counts the number of pixels that are saturated in the determination area. For example, in a case where the luminance level of each pixel of imaging data is expressed by 8 bits from 0 to 255, the pixel at coordinates where the luminance level has a value of 255 is referred to as a saturated pixel. Alternatively, the counting unit 52 may count pixels of coordinates whose pixel output values have values equal to or greater than a predetermined number as the saturated pixels.

The determination unit 53 determines whether or not the rate of the saturated pixels in the determination area is equal to or greater than a threshold. For example, the determination unit 53 obtains the rate of the saturated pixels by dividing the number of saturated pixels in the determination area by all the number of pixels in the determination area. The determination unit 53 compares the rate of saturated pixels in the determination area with a threshold. When the rate of the number of saturated pixels is equal to or greater than the threshold in the determination area corresponding to the target object, the determination unit 53 determines that the target object is not imaged with appropriate temperature resolution or in an appropriate measurement range. The determination unit 53 determines that it is necessary to correct the gain or the offset. The threshold for determining whether or not the correction is necessary may be set in advance. For example, the threshold may be set in accordance with the type of the target object or a certain threshold may be set regardless of the type of the target object. The determination unit 53 may change the threshold in accordance with the type of the target object or the size thereof on the image.

When the rate of the saturated pixels is equal to or greater than the threshold, the change unit 54 changes at least one of the gain or the offset in the far-infrared camera 3. For example, the change unit 54 outputs a control signal to decrease the offset to the far-infrared camera 3. Accordingly, the value of the offset stored in the data storage unit 33 is corrected. For example, the adjustment unit 34 adjusts the pixel output value using a value corrected in such a way that the value of the offset table becomes small by a certain value. That is, the adjustment unit 34 adjusts the pixel output value using a correction table in which the offset value has been corrected.

The amount of correction of the offset value may be a preset fixed value. Alternatively, the amount of correction of the offset value may be set in accordance with the rate of saturation or may be set in accordance with the type of the object. Further, the change unit 54 can change both the gain and the offset or only the offset. Alternatively, the change unit 54 may correct only the gain. When the gain is corrected, the amount of correction of the gain may be a preset fixed value or may be set in accordance with the rate of saturation, just like the amount of correction of the offset value.

The graph B in FIG. 4 shows an example in which saturation of pixels is prevented by changing the offset. The change unit 54 changes the offset in such a way that the saturated pixel output is within the signal processing range (14 bits in FIG. 4). Accordingly, even when variation of the output value occurs, it is possible to prevent pixels in the determination area corresponding to the target object from being saturated and to therefore capture an appropriate far-infrared image.

As described above, the NUC unit 61 performs NUC processing on the far-infrared image. The AGC unit 62 performs automatic gain control processing on the far-infrared image on which the NUC processing has been performed. Accordingly, the brightness of the far-infrared image can be adjusted. The image output unit 63 outputs the far-infrared image on which the AGC processing has been performed to the display 7. The display 7 can thus display a far-infrared image that has been captured appropriately.

That is, an object that needs to be paid attention during traveling is selected as the target object. When there is saturation of a pixel in a determination area corresponding to a target object, the change unit 54 changes the value of the gain or the offset. It is therefore possible to capture a far-infrared image with appropriate temperature resolution and measurement range.

Further, the selection unit 44 gives lower priority to objects that may not have much influence on traveling. Alternatively, the objects that may not have much influence on traveling may not be selected as the target object. For example, the sun, street lamps, lava, and the like, which are objects located at a distance, are not selected as the target object. Since these objects have no influence on traveling, saturation of pixels is allowed. That is, even when the temperature of each of these objects is high, the driver does not need to pay attention. In this case, these objects may be saturated in a far-infrared image. In other words, the gain and the offset are appropriately set by excluding the objects that have no influence on traveling.

In this embodiment, the setting of the far-infrared camera 3 can be made optimal taking into account the variation of the pixel output value. It is therefore possible to increase the temperature resolution of the subject. It is possible to acquire far-infrared images with no saturation.

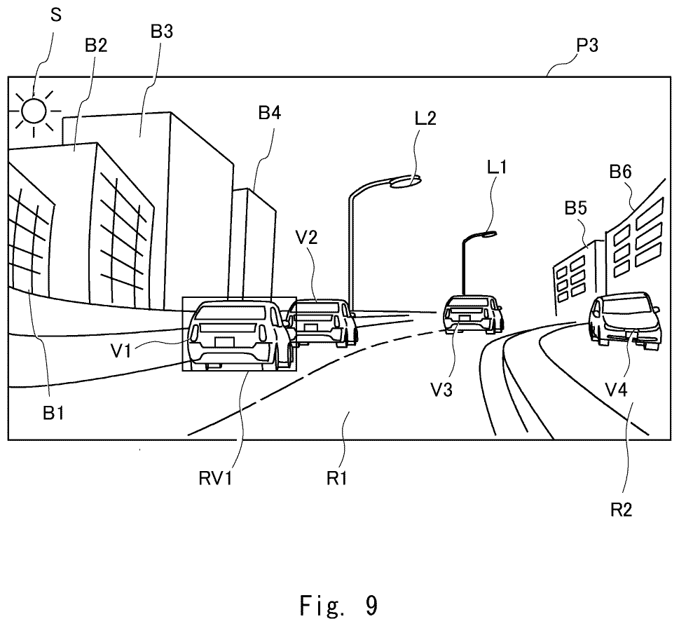

Next, with reference to FIG. 9, processing in a case where there are a plurality of objects whose priority is the highest will be described. An image P3 shown in FIG. 9 includes a plurality of vehicles V1-V4. That is, the object detection unit 43 detects the plurality of vehicles V1-V4. Since the vehicles V1-V4 have the same attribute, their priority is the same: the highest. In this case, the selection unit 44 selects, as the target object, the vehicle V1 with the largest imaged area in the image P3 from among the vehicles V1-V4. From among the vehicles V1-V4, the vehicle V1 has the largest imaged area. That is, the selection unit 44 selects the vehicle V1 with the largest imaged area as the target object. Then the area specifying unit 51 specifies a determination area RV1 corresponding to the vehicle V1. While the vehicle with the largest imaged area is set as the target object in this example, an object imaged at a size equal to or larger than a predetermined size may be set as the target object.

With the aforementioned configuration, the determination unit 53 can make a determination accurately. For example, since the target object is shown in a wider area, the area specifying unit 51 can specify a wider determination area RV1. Accordingly, the number of pixels used by the determination unit 53 for the determination can be increased and the determination can be made accurately.

The priority may be set in accordance with the color and the material of the object. Assume a case where there are black and white vehicles. Even though they are both vehicles, the temperature of the black vehicle tends to be higher than that of the white vehicle due to a difference in the amount of light absorption. Therefore, higher priority is given to the black vehicle and lower priority is given to the white vehicle. With this configuration, the selection unit 44 can select a high-temperature object as the target object. Therefore, by prioritizing objects that are likely to be saturated, it is possible to prevent an abnormal image from being generated.

The control apparatus 4 may include the environment information acquisition unit 56 configured to acquire environment information. The environment information is information including the position of the sun or weather conditions. The environment information may include the weather, a wind direction, a wind speed, a temperature, or the like. The environment information may also include information regarding the position and the orientation of the sun relative to the own vehicle. The environment information may include information on the season. Further, when the imaging system 1 is in-vehicle equipment mounted on a vehicle on which a GPS or the like is mounted, the environment information acquisition unit 56 can acquire weather information at a position of the own vehicle as environment information.

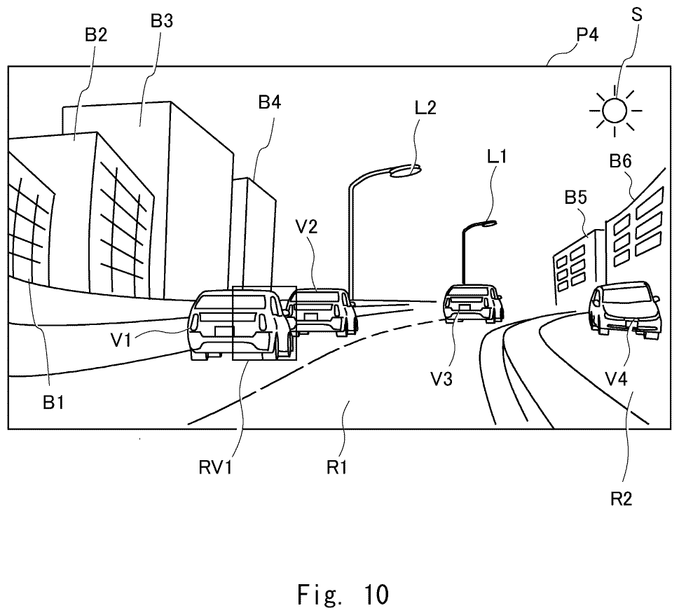

The area specifying unit 51 can specify the determination area based on the environment information. With reference to FIG. 10, an example in which the area specifying unit 51 specifies the determination area based on the environment information will be described. In FIG. 10, a vehicle V1 is selected as a target object. It is assumed that the right half of the vehicle V1 is exposed to direct sunlight in a far-infrared image P4. It is therefore assumed that the right half of the vehicle V1 absorbs more sunlight than the left half does and therefore the temperature of the right half of the vehicle V1 is higher than that of the left half thereof. In this case, the area specifying unit 51 specifies the right half of the vehicle V1 as a determination area RV1.

Alternatively, the area specifying unit 51 may specify the determination area based on information such as a wind direction. For example, the environment information acquisition unit 56 includes an anemometer that measures the wind direction or the wind speed. Alternatively, the environment information acquisition unit 56 may acquire information indicating the wind direction or the wind speed from the anemometer mounted on the own vehicle. The area specifying unit 51 specifies the determination area excluding the part that receives a cold wind. When, for example, the vehicle V1 receives a cold wind from the left side, the area specifying unit 51 specifies the right half of the vehicle V1 with a high possibility of saturation as the determination area RV1.

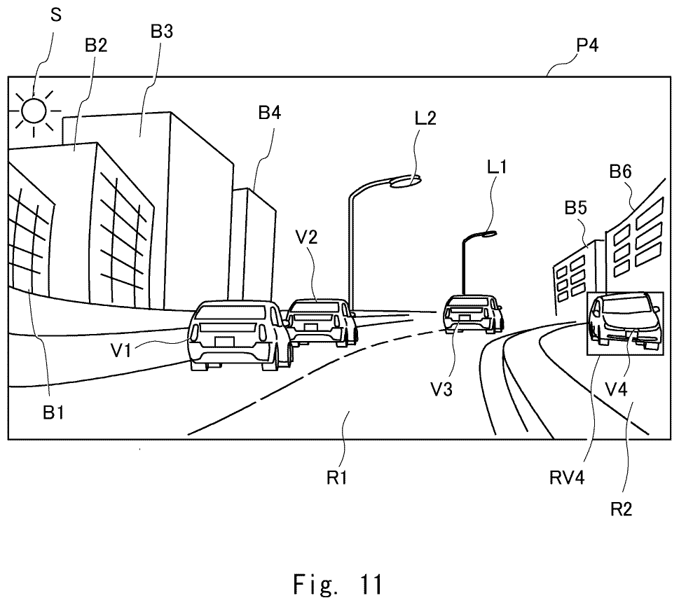

Further, the selection unit 44 may select the target object based on environment information. With reference to FIG. 11, an example in which the selection unit 44 selects a target object based on the environment information will be described. In FIG. 11, a vehicle V4 is selected as the target object. It is assumed, in a far-infrared image P4, that a road R1 on the left side is in the shade due to the presence of buildings B2, B3, and the like. A road R2 on the right side is in the sunshine. In the road R2 which is in the sunshine, the temperature of objects increases due to sunlight. That is, the temperature of the vehicle V4 traveling on the road R2 is high because the vehicle V4 is exposed to sunlight. In contrast, since vehicles V1-V3 traveling on the road R1 are not exposed to sunlight, the temperature thereof is relatively low. Therefore, the selection unit 44 selects the vehicle V4 as the target object. That is, the vehicle V4 whose temperature is high is the target object, not the vehicle V1 which occupies the largest area on the image. The area specifying unit 51 specifies a determination area RV4 including the vehicle V4.

When information regarding the sunshine and the shade is known based on the environment information, the priority can be changed depending on whether an object is in the sunshine or in the shade. That is, the selection unit 44 gives higher priority to objects in the sunshine and lower priority to objects in the shade. Accordingly, the selection unit 44 can appropriately select a target object. Alternatively, when the wind direction, the wind speed, and so on are known based on the environment information, the selection unit 44 may change the priority depending on them. For example, lower priority may be given to an object that is cooled by cold wind.

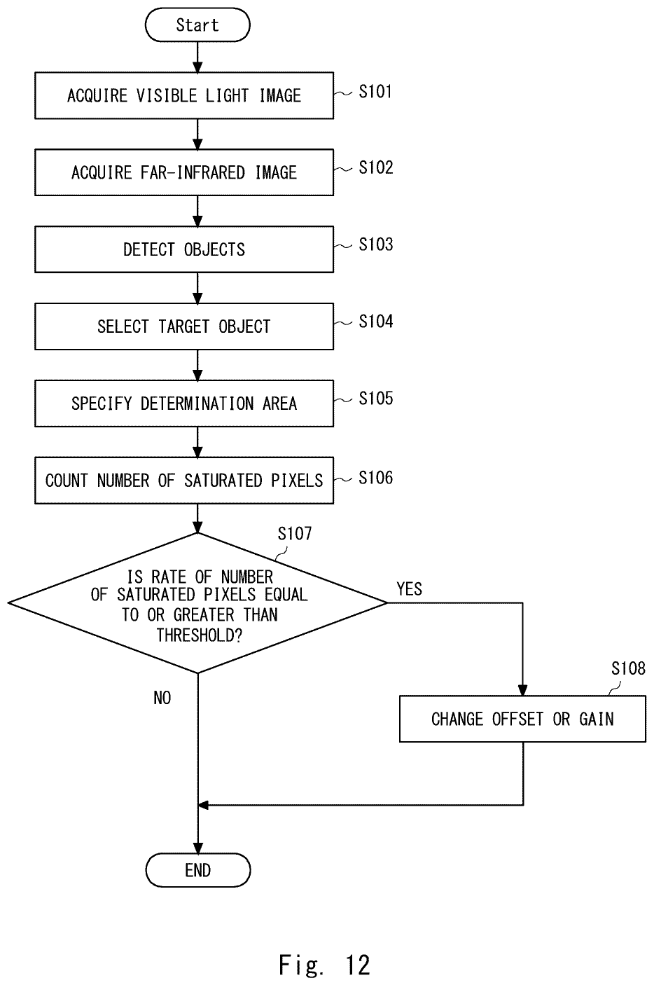

With reference to FIG. 12, an image adjustment method will be described. FIG. 12 is a flowchart showing the image adjustment method. The visible light image acquisition unit 41 acquires a visible light image from the visible light camera 2 (S101). The far-infrared image acquisition unit 42 acquires a far-infrared image from the far-infrared camera 3 (S102). The object detection unit 43 detects objects included in the visible light image (S103). The object detection unit 43 recognizes the objects in the visible light image by known image recognition processing.

The selection unit 44 selects a target object from among the objects included in the visible light image (S104). The selection unit 44 selects the target object by referring to priority information indicating priority set for each object. In this example, one of the objects included in the visible light image is selected as the target object.

The area specifying unit 51 specifies a determination area corresponding to the target object in the far-infrared image (S105). That is, the pixel address of the part of the target object in the visible light image is converted into a pixel address in a far-infrared image. The installation angles and the angles of view of the visible light camera 2 and the far-infrared camera 3 are known. Therefore, the area specifying unit 51 can specify the determination area of the target object in the far-infrared image by using a conversion expression or a conversion table of the pixel address.

The counting unit 52 counts the number of saturated pixels in the determination area (S106). The counting unit 52 obtains the number of saturated pixels in the determination area. The determination unit 53 determines whether or not the rate of the saturated pixels in the determination area is equal to or greater than a threshold (S107). That is, the determination unit 53 obtains the rate of the saturated pixels in the determination area by dividing the number of saturated pixels by all the number of pixels included in the determination area. The determination unit 53 compares the rate of the saturated pixels with the threshold.

When the rate of the saturated pixels is not equal to or greater than the threshold (NO in S107), the process ends. That is, the gain or the offset in the far-infrared camera 3 is not changed. When the rate of the saturated pixels is equal to or greater than the threshold (YES in S107), the change unit 54 changes the gain or the offset of the far-infrared camera 3 (S108). That is, the change unit 54 outputs a control signal for changing the value of the gain or the offset to the far-infrared camera 3. The amount of correction of the value of the gain or the offset may be a predetermined value set in advance or may be set according to the rate of the saturated pixels or the like. Then the process ends.

The imaging system 1 repeatedly performs the aforementioned processing. For example, the imaging system 1 performs the aforementioned processing every single frame or every multiple frames. Accordingly, the control apparatus 4 can adjust the image in such a way that the temperature resolution becomes an appropriate temperature resolution.

When a plurality of objects whose priority is the same are included in the visible light image, the selection unit 44 may select the target object in accordance with the area of the object on the image in S104. That is, the selection unit 44 selects, as the target object, the object having the largest area on the image from among the plurality of objects whose priority is the same. Accordingly, as shown in FIG. 9, the vehicle V1 is selected as the target object.

In S104, the selection unit 44 may select the target object based on the environment information acquired by the environment information acquisition unit 56. When, for example, the environment information includes information indicating shade or sunshine, the selection unit 44 gives higher priority to objects in the sunshine. Accordingly, as shown in FIG. 11, the vehicle V4 is selected as a target object. Alternatively, when the environment information includes information indicating the wind speed or the wind direction, the selection unit 44 gives lower priority to objects that are being cooled.

Further, in S105, the area specifying unit 51 may specify the determination area based on the environment information acquired by the environment information acquisition unit 56. When, for example, the environment information includes information indicating whether an object is in the shade or in the sunshine, a part of the vehicle V1 is selected as the determination area RV1, as shown in FIG. 10.

The control apparatus 4 functions as an image adjustment apparatus that adjusts far-infrared images of the far-infrared camera 3. The control apparatus 4 is not limited to a physically single apparatus and may be arranged in a plurality of apparatuses in a distributed manner. For example, some of the functions of the control apparatus 4 may be mounted on the visible light camera 2 or the far-infrared camera 3. The object detection function may be mounted on the visible light camera 2. The processing function such as the determination unit may be mounted on the far-infrared camera 3.

The program of the control apparatus 4 and the imaging system 1 described above includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present invention is not limited to the aforementioned embodiments and may be changed as appropriate without departing from the spirit of the present invention.

What is claimed is:

1. An image adjustment apparatus comprising:
a first image acquisition unit configured to acquire a first image captured by a first image-capturing element;
a second image acquisition unit configured to acquire a second image captured by a second image-capturing element that detects far-infrared light;
an object detection unit configured to detect objects included in the first image;
a selection unit configured to select a target object from among the objects included in the first image by referring to priority information given to objects;
an area specifying unit configured to specify a determination area including the target object in the second image;
a counting unit configured to count the number of saturated pixels that are saturated in the determination area;
a determination unit configured to determine whether or not a rate of the saturated pixels in the determination area is equal to or greater than a threshold; and
a change unit configured to change, when the rate is equal to or greater than the threshold, a value of a gain or an offset in the second image-capturing element.

2. The image adjustment apparatus according to claim 1, wherein the selection unit refers to the priority information set according to the temperature of the object or the type of the object.

3. The image adjustment apparatus according to claim 1, wherein, when a plurality of objects whose priority is the same are included in the first image, an object with the largest imaged area in the first image is selected as a target object from among the plurality of objects whose priority is the same.

4. The image adjustment apparatus according to claim 1, wherein, when a plurality of objects whose priority is the highest are included in the first image, an object with the largest imaged area in the first image is selected as a target object from a plurality of objects whose priority is the highest.

5. The image adjustment apparatus according to claim 1, further comprising:
an environment information acquisition unit configured to acquire environment information including a position of the sun or a weather condition,
wherein the area specifying unit specifies the determination area in accordance with the environment information.

6. The image adjustment apparatus according to claim 1, further comprising:
an environment information acquisition unit configured to acquire environment information including a position of the sun or a weather condition,
wherein the selection unit changes the priority information in accordance with the environment information and selects the target object.

7. The image adjustment apparatus according to claim 1, wherein
the image adjustment apparatus is mounted on a mobile body such as a vehicle, and
the selection unit selects, from among the objects included in the first image, an object that affects traveling of the mobile body as the target object.

8. An image adjustment method comprising:
a step of acquiring a first image captured by a first image-capturing element;
a step of acquiring a second image captured by a second image-capturing element that detects far-infrared light;
a step of detecting objects included in the first image;
a step of selecting a target object from among the objects included in the first image by referring to priority information given to objects;
a step of specifying a determination area including the target object in the second image;
a step of counting the number of saturated pixels that are saturated in the determination area;
a step of determining whether or not a rate of the saturated pixels in the determination area is equal to or greater than a threshold; and
a step of changing, when the rate is equal to greater than the threshold, a value of a gain or an offset in the second image-capturing element.

9. A non-transitory computer readable medium storing a program for causing a processor that controls an image adjustment apparatus to perform:
a step of acquiring a first image captured by a first image-capturing element;
a step of acquiring a second image captured by a second image-capturing element that detects far-infrared light;
a step of detecting objects included in the first image;
a step of selecting a target object from among the objects included in the first image by referring to priority information given to objects;
a step of specifying a determination area including the target object in the second image;
a step of counting the number of saturated pixels that are saturated in the determination area;
a step of determining whether or not a rate of the saturated pixels in the determination area is equal to or greater than a threshold; and
a step of changing, when the rate is equal to greater than the threshold, a value of a gain or an offset in the second image-capturing element.
